(19) United States
(12) Patent Application Publication
(10) Pub. No.: US 2003/0208622 A1
(43) Pub. Date: Nov. 6, 2003

(54) Method and system for multiple vendor, multiple domain router configuration backup

(76) Inventor: James R. Mosier, Apex, NC (US)

Correspondence Address: Paul A. Roberts, WorldCom, Inc., Technology Law Department, 1133 19th Street N.W., Washington, DC, 20036, US

(21) Appl. No.: 10/136,236

(22) Filed: May 1, 2002

(51) Int. Cl. G06F 15/177; G06F 15/173

(52) U.S. Cl. 709/244; 709/220

(57) ABSTRACT

The present invention is directed to a method, system and computer program product for backing up network device configuration data for customers of a service center which maintains multiple types of vendors' network equipment maintained in multiple domains. Initially, network configuration data for customer networks in each IP domain are kept current by polling a network management application on a regular basis. An audit process audits customer files in a network management application's database to discover new customers and nodes to add to a service center database. Additionally, the audit process removes customers or nodes that have dropped off the domain. An e-mail is sent to administrators with the results of the audit. A backup process also performs backups on network device configuration data on a regular basis or more frequently if device configuration data is absent or stale from the service center database. When acquiring backup configuration data, two attempts will be made to back up each network device. The first attempt is the least expensive means (processor/time); the second attempt is a more brute force method. Configuration data is backed up in the service center database for use in the event of a catastrophic failure. A weekly report is automatically sent to the managers with team, customer and/or cumulative backup summary data.

### BACKGROUND OF THE INVENTION

1. Field of the Invention

The present invention relates generally to data transmission, and more particularly to a method, system and computer program product for backing up network device data. Still more particularly, the present invention relates to a mechanism for discovering, scheduling, and performing configuration backups for customers of a service center with multiple types of vendors' network equipment maintained in multiple domains.

2. Description of Related Art

Corporations that operate networks must invariably maintain a certain amount of network equipment in support of those networks such as routers, gateways, bridges, servers, etc. Rarely does a corporation utilize one particular vendor type of equipment. Instead, the enterprise is often faced with the task of maintaining network devices from a plurality of different vendors and even within a particular vendor a variety of different device models based on a variety of different standards and protocols. Often a corporation will contract a service organization, such as Global Network Operations (GNO), to provide support for those network devices while the corporation maintains control of the content. The GNO is responsible, inter alia, for backing up critical network device setting in case of a catastrophic event. In order to back up network devices, the GNO must comprehend the bounds and configuration of its customers' networks.

Network management is somewhat simplified by the introduction of network management products for managing complex networks. Typically, a network management application (NMA) sees all networks in a predefined network domain, and can access or view network device databases connected to networks within the predefined domain. The NMA is usually hosted on a special server known as a “domain application server” which may be owned by the customer or might be owned instead by the GNO. A domain is not necessarily customer specific. Thus, the GNO might define domains with multiple customers. Alternatively, domains may be defined by any criteria important to the customer or GNO for managing the networks within the domain. Because a GNO must have multiple customers to be successful, the GNO will be responsible for servicing a variety of vendor types of network devices maintained in multiple domains which, in turn, may be managed by a variety of vendor types of NMAs. Furthermore, large GNOs are frequently subdivided into service teams responsible for specific customers, domains or both.

Auditing often requires the GNO teams to utilize several different network management products in view of a customer's network in order to visualize network configuration data. Some products are more automated and more user friendly than others. Some network management products auto-discover customer networks, network configurations, all nodes and network devices attached to the network. Additionally, some products sense when a network device has been added or deleted on a network, while others require the administrator to manually view the network configuration to determine new nodes and devices.

Backing up router configuration data requires accurate network configuration data for each domain being serviced by the GNO. Backing up router configuration data is often seen as a low priority task by a GNO. While GNO team members may consider acquiring initial configuration backup data for new customers or new routers a high priority, long periods of time often lapse between backup attempts once backup configuration data has been acquired. Excessive time between router backups results in existing router configuration data becoming stale and out of date due to normal customer router configuration updates and changes. Because most GNO customers employ a variety of vendor's router types, backup procedures become rather complicated and are multi-tiered processes which require the involvement of more experienced GNO team members. Some vendors' routers may go through several backup events without their configuration data being backed up. Another problem is that some, if not all, GNO teams must utilize several different network management products in order to back up their customers' routers configuration data (or for auditing their GNO domains).

Additionally, it is difficult to identify trends that may need further investigation by the GNO because each GNO team is largely responsible for its own GNO domain(s). Thus, a shortcoming linked to a particular vendor router type, customer network, or even network management product oftentimes goes undetected because the crucial data necessary for identifying the trend is dispersed between several GNO teams. Moreover, with respect to router backup procedures, it becomes increasingly difficult for the GNO to identify a GNO team's weaknesses because the teams are largely autonomous and their shortcomings are either unrealized or unreported. Moreover, network management databases are frequently difficult or impossible to organize by customer, customer network, vendor router type or GNO team. Thus, while a particular problem may be apparent by carefully scrutinizing the backup event data from the NMA(s), the data itself is generally not configurable using the network management tool itself and must be analyzed using some other mechanism.

### BRIEF SUMMARY OF THE INVENTION

The present invention is directed to a method, system and computer program product for backing up network device configuration data for customers of a service center who maintain multiple types of vendors' network equipment maintained in multiple domains. Initially, network configuration data for customer networks in each IP domain are kept current by polling a network management application on a regular basis. An audit process audits customer files in a network management application's database to discover new customers and nodes to add to a service center database. Additionally, the audit process removes customers or nodes that have dropped off the domain. An e-mail is sent to administrators with the results of the audit. A backup process also performs backups on network device configuration data on a regular basis or more frequently if device configuration data is absent or stale from the service center database. When acquiring backup configuration data, two attempts will be made to back up each network device. The first attempt is the least expensive means (processor/time); the second attempt is more of a brute force method. Configuration data is backed up in the service center database for use in the event of a catastrophic failure. A weekly report is automatically sent to the managers with team, customer and/or cumulative backup summary data.

### BRIEF DESCRIPTION OF THE DRAWINGS

The novel features believed characteristic of the invention are set forth in the appended claims. However, the invention itself, as well as an exemplary mode of use, further objectives and advantages thereof, will be best understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1A is a diagram representing a portion of a typical global telecommunications network configured to pass packets of data based in accordance with the Internet Protocol (IP);

FIG. 1B is a diagram representing the portion of a typical global telecommunications network shown in FIG. 1A that also shows each GNO IP domain with an IP domain application server for hosting a network management application for managing complex networks defined within the GNO IP domain and a GNO team infrastructure;

FIG. 2 is a flowchart depicting a high-level view of the B3D process for automatically auditing IP domains and backing up configuration data for customers' routers attached to networks in the audited domains in accordance with an exemplary embodiment of the present invention;

FIG. 3 is a flowchart depicting a low-level view of the B3D audit process for auditing IP domains and backing up configuration data for customers' routers attached to networks in the audited domains in accordance with an exemplary embodiment of the present invention;

FIG. 4 is a flowchart depicting a low-level view of the B3D backup process for backing up router configuration data for routers in the GNO IP domains in accordance with an exemplary embodiment of the present invention;

FIGS. 5A and 5B are screen shots depicting a router configuration backup summary and are shown in accordance with an exemplary embodiment of the present invention;

FIGS. 6A and 6B are screen shots depicting a router configuration backup GNO team summary and are shown in accordance with an exemplary embodiment of the present invention; and

FIGS. 7A and 7B are screen shots depicting a router configuration backup GNO customer summary and are shown in accordance with an exemplary embodiment of the present invention.

Other features of the present invention will be apparent from the accompanying drawings and from the detailed description which follows.

### DETAILED DESCRIPTION OF THE INVENTION

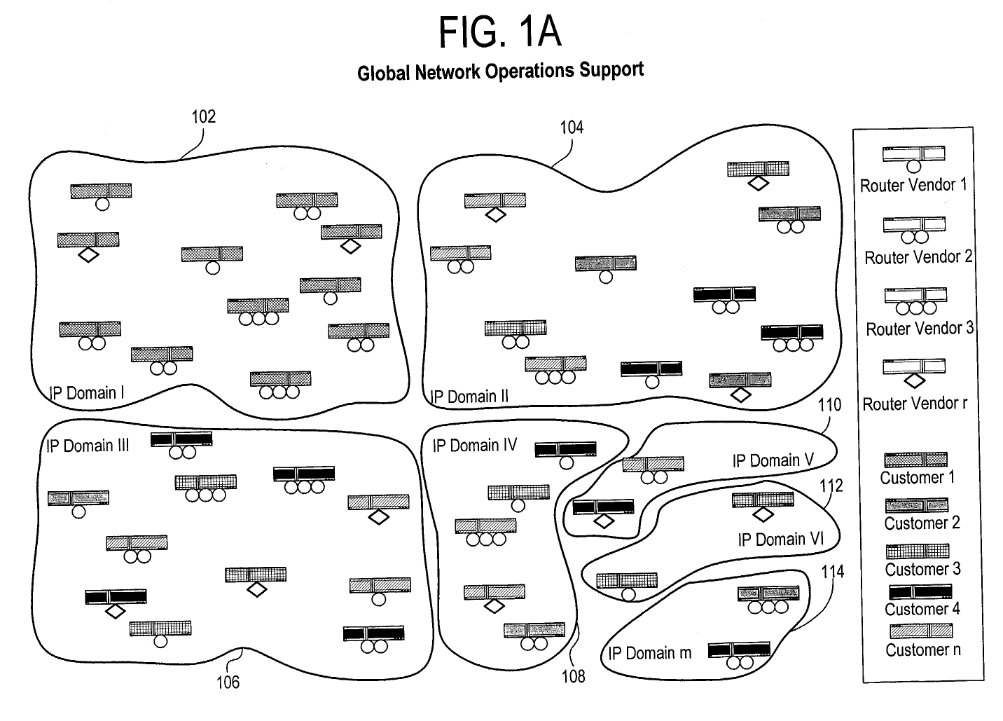

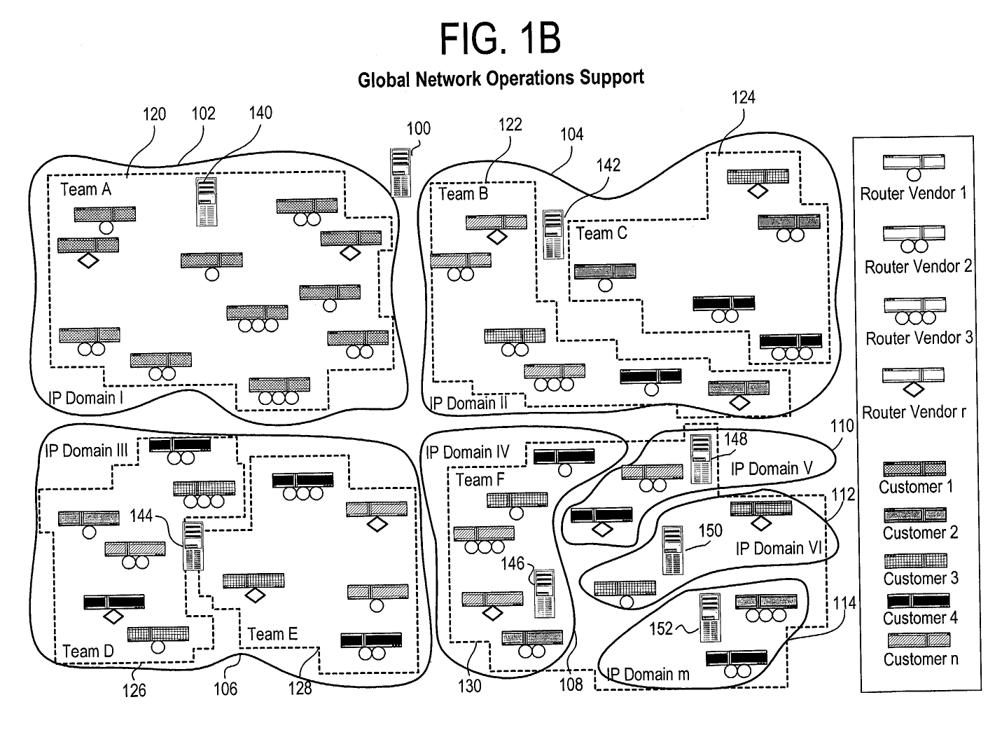

FIG. 1A is a diagram representing a portion of a typical global telecommunications network configured to pass packets of data based in accordance with the Internet Protocol (IP). It should be understood that the global network depicted in FIGS. 1A and 1B are merely a representative network suitable for the discussion of the present invention, and not as an architectural limitation for the processes of the present invention.. In the instant diagram, the global network being depicted is only the portion of the global IP network being supported by a Global Network Operations (GNO), but otherwise functions on the basis of the Internet Protocol (IP) as is well understood in the art. The global IP network depicted in the Figure is subdivided into separate domains based in IP domains (i.e., IP Domain I 102, IP Domain II 104, . . . IP Domain m 114). A typical network domain consists of a set of network addresses, usually with some commonality, and in the case of an IP domain, is often organized in levels. The top IP level identifies geographic or purpose commonality, for example, the nation that the domain covers (e.g., us, .au, .uk, etc., or a category such as .com for commercial, net for network, .gov for government, .org for organization, etc.). A second IP domain level identifies a unique place within the top level domain and is specified by a unique address in the IP network (an IP address). The second level domain, sometimes referred to as the “domain name,” is the portion of a Uniform Resource Locator (URL) that identifies the specific and unique administrative owner associated with an IP address. The second domain level often identifies a corporation or company by name or its product information (e.g., WorldCom, RedCross, USPTO, etc.). Often, an IP domain distinguishes a group of network devices whose host names share a common suffix (e.g., the domain name). Even lower domain levels may also be utilized. However, for purposes of describing the present invention, a GNO domain may be thought of as a group of computers, router and other network devices with common rules and procedures that are administered as a unit by the GNO. If the GNO domain is an IP domain, then the rules and procedures are compliant with the Internet protocol.

As may be evident from FIG. 1A, the depicted global IP network is subdivided into many GNO IP domains (i.e., IP Domain I 102, IP Domain II 104, . . . IP Domain m 114). Each of GNO IP domains 102-114 may correspond to a top level IP domain such as .com, net, .au, .uk, etc., or instead to a second level IP domain such as WorldCom, RedCross or USPTO, or some combination of the two IP levels. Alternatively, for purposes of the present invention, a GNO IP domain may be defined as network devices whose network addresses are maintained on list network devices supported by a GNO. The list might be compiled on the basis of customers, geography or some other criteria based on the GNO support infrastructure.

As is well known by those skilled in the art, a network is a plurality of network devices, routers, gateways, etc. for determining the next network point to which a packet should be forwarded toward its final destination node. Thus, as GNO IP Domains I 102-m 114 may be artificially defined by the GNO administration, the network devices within the separate domains may not directly connect to one another (i.e., may be more than one hop from each other). Therefore, other routers that may be needed to support a functioning network are not shown in FIGS. 1A and 1B. FIGS. 1A and 1B are intended to depict only the portion of the global IP network serviced by a GNO. Although not explicitly depicted in the present Figure, a router (or a computer functioning as a router) is typically connected to at least two networks and decides which way to send each information packet based on its current understanding of the state of the networks to which it is connected. The routers illustrated in FIGS. 1A and 1B are intended to depict only boundary or gateway routers serviced by a GNO for its customers and, as such, connect between the global IP network and the customer's Local Area Network (LAN) or Wide Area Network (WAN). It should be appreciated, although not shown in FIG. 1A, many other routers and network devices are connected to each depicted boundary router which necessarily define the separate LANs and WANs for a functioning network topology.

Notice from FIG. 1A that contained within the depicted global IP network, and within each separate IP domain, are several different types of routers supplied by various router vendors. Some exemplary types of routers and vendors are the 12000, 100 and 7600 series Internet routers available from Cisco Systems of San Jose, Calif.; the Backbone Link Node, Access Stack Node, and Backbone Node (BN) Router Family series available from Nortel Networks Corp of Brampton, Canada; and M-series Routers available from Juniper Networks, Inc. of Sunnyvale, Calif. Unique types of routers are depicted in the Figure as having a unique symbol representative of a particular router vendor (i.e., one to three balls or a diamond conjoining the router symbol). As is well understood in the art, an IP domain may be defined as a multitude of different types of routing hardware from various vendors. Therefore, with respect to the discussion of the present invention, a GNO IP domain may be defined as a multitude of different types of routers from various vendors serviced by GNO personnel.

For purposes of the present description, it should be further appreciated that a single GNO IP domain may be composed of more than one company's network routers. As the depicted GNO IP domains may be defined by the GNO itself, some GNO IP domains may contain routers from a plurality of customers, while other GNO IP domains may contain only one customer's routers. Defining the individual GNO IP domains might be based on GNO infrastructure limitations such as the physical location of customer networks, GNO manpower limitations and skill level, network complexity or any other GNO criteria for subdividing the portion of the global IP network serviced by the GNO into more manageable domains. While some GNO IP domains may contain a plurality of GNO customer's routers, other GNO IP domains may be defined by larger individual GNO customers. One possibility is to define a GNO IP domain as a predefined, second-level IP domain as described hereinabove. Thus, a second-level IP domain of a larger GNO customer might correlate to a GNO IP domain. An example of such a GNO IP domain can be seen in the global IP network of FIG. 1A in GNO IP Domain I 102.

Still again, GNO IP domains might also correlate predefined top-level IP domains as also described hereinabove. In that case, a large GNO customer might have network routers in more than one GNO IP domain, while smaller GNO customers might have network routers in only one GNO IP domain. For instance, any larger corporation operates in a variety of IP domains, such as of .com, net, and .au, and would therefore have routers for each top-level IP domain that correlates to a GNO IP domain, while many government agencies would maintain routers in only the .gov IP domain. An example of a company maintaining routers in multiple GNO IP domains, where GNO IP domains correlate to top-level domains, is customer 2 with routers in GNO IP Domains II 104, III 106, IV 108 and m 114, whereas customer 1 maintains routers only in GNO IP domain I 102.

Notice also that GNO IP Domain I 102 depicts the single GNO customer as maintaining a plurality of different vendor router types within that GNO IP domain. Similarly, each of customers 1-n utilize different vendor router types in the various GNO IP domains that they maintain routers. However, in some GNO IP domains (i.e., GNO IP Domains V 110, VI 112 and m 114), customers use only a single vendor's router type. This situation is possible in cases where small enterprises need only modest bandwidth to the global IP network and have limited internal LANs. However, recall that FIGS. 1A and 1B depict merely the boundary routers between the global IP network and a customer's LAN1. Therefore, it is more likely that even companies with modest bandwidth needs will have several types of vendor routers connected to their internal LANs. Those internal routers (not shown in the present Figure) would most likely be supported by the GNO.

As alluded to above, it is the primary responsibility of the GNO to administer network devices owned by customers. A global GNO may support tens of thousands of different customers with various types of vendor routers configured with myriad network configurations based on the customer's requirements. One chief function of the GNO is to maintain a copy of eac4h router's network and configuration files for emergency restoration. However, in order to back up a router's network and configuration files, the GNO must track changes in its customers' networks and network equipment which is a major undertaking if the GNO has an extensive customer base. The problem is exacerbated by the global GNO IP network being subdivided into separate GNO IP domains in which all networks, subnets and attached network devices must be discovered. Thus, it is often difficult for the GNO to accumulate a global summary of temporal backup router data for all GNO customers due to the amount of time necessary to compile data from every GNO IP domain. The summary is often out of date and inaccurate at key event times, such as scheduled backup events. Summarizing backup router data by customer is less problematic when the GNO IP domains are defined to correlate to GNO customers. However, summaries of backup router data for GNO customers is even more problematic when GNO customers maintain routers in more than one GNO IP domain because the global summary must be compiled and then parsed by customer without regard to GNO IP domain. Therefore, very often GNO customer summary router backup data is even more out of date and possibly more inaccurate than the global summary data. However, obtaining temporal router backup data for the global GNO network or for an individual is even more complicated than might be imagined. This can be better appreciated by considering the infrastructure of a typical GNO as will be discussed with respect to FIG. 1B.

Before describing the GNO service team structure, it should be first understood that the GNO utilizes specialized equipment for discovering and tracking a customer's network devices maintained within a GNO IP domain. Typically, each GNO IP domain will have an IP domain application server for hosting a network management application (NMA) for managing complex networks defined within the GNO IP domain. IP domain application servers are represented in FIG. 1B as servers 140-152, each of which corresponds to GNO IP domains I 102-m 114, respectively. A typical NMA performs several functions which are useful in view of the discussion of the present invention, but it is usually a suite of network management tools helpful for various network management functions other than router backup. A suitable NMA should allow GNO server personnel to visualize network topologies and configurations, discover new network devices connected to the network and recognize when a network device drops off the network. NetView, a trademark of and available from IBM Corporation of Armonk, N.Y.; OpenView, available from the Hewlett-Packard Company of Palo Alto, Calif.; Solstice SunNet Manager, a trademark of and available from Sun Microsystems of Palo Alto, Calif.; and ManageWise available from Novell, Inc. of Provo, Utah are examples of network management products used for, among other things, visualizing network topologies, configurations and critical event occurrence.

These products allow service organizations like a GNO to be informed via, for instance, an alpha-numeric page when critical events occur and the management console is notified. Additionally, proactive event notification can be used best by GNOs to provide early problem detection leading to a quick resolution, thereby solving problems before customers can even detect an error. Network management products, like NetView and OpenView, utilize the Simple Network Management Protocol (SNMP) which governs network management and monitors network devices and their functions, for managing complex networks. SNMP-compliant devices, sometimes referred to as “called agents,” store data about themselves in Management Information Bases (MIBs). MIBs are a database of managed objects that can be monitored by the NMA connected to the subject network. The SNMP NMA can query or set in the SNMP agent of a network device (e.g., router) and return this data to the SNMP requester NMA. Because NMAs are so inexorably linked to network device data acquired from the device MIB, they are often referred to as “MIB viewers.”

Here it should be understood that, although the present invention is described in terms of the IP compliant networks and network devices, the present invention will work equally well for non-IP compliant networks and network devices because, as will be described below, the present invention relies on information from the NMA which, in turn, acquires topologies, network and router configurations from the network devices, whether or not they are IP compliant or even SNMP compliant. Thus, the GNO domains have been defined as being Internet protocol domains. However, as will be more apparent from the discussion below, the functionality of the present invention, herein referred to as the “router configuration backup” or “B3D,” is hosted on a Centralized Multiple Domain Server (CMDS) and is dependent upon the existence and proper configuration of the IP domain application servers (described in detail below). The Managed Service Development (MSD) application has accepted the standard configuration document for the domain application servers. Thus, the B3D functionality is not dependent upon the IP complacency, or even SNMP compliance, but may include non-IP network management applications such as INVENSYS, available from Invensys Software Systems, Herndon, Va., or Spectrum, a trademark of and available from Cabletron Systems, Rochester, N.H.

The global GNO IP network represented in FIG. 1B is identical to that shown in FIG. 1A with an exemplary GNO service support infrastructure superimposed thereon. A GNO service may be required to provide support for a variety of customers, each of which operates various router types in one or many IP domains. Moreover, the customer hardware may be physically positioned in different locations. It is the responsibility of the GNU service personnel to administer the different router types for their clients, regardless of the type or physical location of the hardware. A global GNO may support tens of thousands of different customers with an assortment of vendor router types having various network configurations. Furthermore, as the GNO infrastructure expands to better serve the needs of its customers, the GNO service personnel are often subdivided into separate departments or teams based on customer, GNO domain, physical location or some other criteria decided upon by the GNO for managing its customer's equipment. Notice in FIG. 1B that the GNO is broken up into seven representative teams, Teams A 120-F 130. GNO teams may be defined to correspond to GNO IP domains, customers, top-level IP domains, second-level IP domains, physical location of the team or the customer equipment, or some other criteria decided upon by the GNO. With respect to the portion of the global IP network being supported by the GNO depicted in FIG. 1B, GNO Team A 120 is defined as correlating to an GNO IP domain (i. e., Team A handles all customers that maintain routers connected to GNO IP Domain I 102). This approach is practical only insofar as the number of customers maintaining routers in GNO IP domain in 102 remains manageable. It is assumed that the GNO has previously determined an optimal size (number of employees and structure) for a working GNO team.

At some point as the total volume of network equipment in GNO IP Domain I 102 increases, whether as a result of new customers being added to the domain or existing customers expanding their networks, the volume of network equipment will exceed the capacity of Team A to support it. In that case, assuming that Team A is fully staffed, a portion of the customers in the GNO IP domain are assigned to other GNO service teams. GNO IP Domain II 104 is exemplary of the case where a GNO IP domain is supported by two different GNO teams, Team B 122 and Team C 124, as is GNO IP Domain III 106 which is supported by Teams D 126 and E 128. GNO IP Domains IV 108-m 114 are representative of the opposite case where the capacity of a GNO service team exceeds the total volume of network equipment in an GNO IP domain. In that case, a single GNO service team might support two or more GNO IP domains, such as GNO Teams F 130 simultaneously supporting GNO IP domains IV 108, V 110, VI 112 and m 114.

Referring again to FIG. 1B, each of GNO IP Domains I 102-m 114 are characterized as having an IP domain server for hosting a vendor's NMA for managing customer networks visible within the respective GNO IP domain. For example, IP domain server 140 handles customer networks in GNO IP Domain I 102; IP domain server 142 handles customer networks in GNO IP Domain II 104; IP domain server 144 handles customer networks in GNO IP Domain III 106, etc. Notice that GNO Team A 120 has the exclusive use of IP domain server 140 because Team A 120 is responsible for only IP Domain I 102 customers. It follows then that Team A 120 need access only one vendor's NMA hosted on IP domain server 140 for configuration backup information for any customer's router maintained in GNO IP domain I 102. In accordance with other situations, multiple GNO service teams access the same NMA for different GNO customers located in the same GNO IP domain, because the GNO IP domain is serviced by multiple GNO service teams. For example, IP domain server 142 handles customer networks in GNO IP Domain II 104 which is serviced by both GNO Team B 122 and GNO Team C 124. Similarly, IP domain server 144 handles customer networks in GNO IP Domain III 106 which is serviced by GNO Team D 126 and GNO Team E 128. However, when a GNO service team provides service to customers maintaining network equipment in more than one GNO IP domain, that GNO team must access multiple NMAs located on IP domain servers in the GNO IP domains where the customers maintain routers. This is the case for GNO Team F 130 which services customer network equipment in GNO IP Domains IV 108, V 110, VI 112 and m 114. Moreover, these NMAs might be products from several vendors requiring Team F's service personnel to be proficient with each type of network management product.

Whenever a GNO support team is defined by a customer and the GNO IP domain does not correspond to the customer, larger customers will invariably maintain a presence in multiple IP domains. In those cases, the GNO teams supporting those customers must also interface with multiple NMAs for the separate GNO IP domains. Thus, often GNO teams must rely on several competing vendors' NMAs for a single customer's crucial data concerning a customer's network routers and is not available as a unified listing for the customer. Furthermore, while the MIBs associated with the customer's network devices may be specified by a SNMP, once pertinent data is collected from the device MIBs by a particular NMA, that application usually restructures the network device data in accordance with a vendor specific proprietary specification. Therefore, collecting and organizing router backup information from multiple vendor's NMAs is extremely time consuming for the GNO team servicing that customer (e.g., Team F 130).

From the foregoing, it can be understood that the problems encountered by Team F 130 are the identical problems faced by the GNO in microcosm. These problems can be divided into two categories: audit and backup. Auditing involves the GNO team identifying GNO IP domains, customers with networks in a specific GNO IP domain, and discovering customer networks and network configurations, nodes and network devices attached to the nodes. An accurate audit is essential for backing up customer configuration data. Only when every network device for which the GNO team is responsible is identified can its configuration data be backed up. Backing up router configuration data involves ensuring that network and router configurations data for the customer's network and network devices are available, and if not, acquiring the backup configuration data, and finally, periodically backing up network and router configurations data for all of the customers' network devices.

Auditing often requires the GNO teams to utilize several different network management products in view of customer network and visualizing network configuration data. Some products are more automated and user friendly than others. Some network management products auto-discover customer networks, network configurations, all nodes and network devices attached to the network. Additionally, some products sense when a network device has been added or deleted on a network, while others require the administrator to manually view the network configuration to determine new nodes and devices. Auditing a GNO IP domain may require the expertise of more experienced GNO team members in order to accurately determine existing network devices and, sometimes even more importantly, to determine network state changes brought about by additions or deletions. Moreover, even if the GNO team uses only a single network management product, the team members must be aware of newly-defined GNO IP domains for which the team is responsible. If a NMA is not configured for a specific IP domain, is simply cannot see the domain and will not recognize customer networks or devices maintained in that domain.

Backing up router configuration data is even more problematic for the GNO teams for several additional reasons. Firstly, backing up router configuration data is often seen as a low priority task by GNO team personnel who must face dealing with an endless procession of critical events. While GNO team members may consider acquiring initial configuration backup data for new customers or new routers a high priority, often long periods of time lapse between backup attempts once backup configuration data has been acquired. Excessive time between router backups results in existing router configuration data becoming stale and out of date due to normal customer router configuration updates and changes. Secondly, as alluded to above, most customers employ a variety of vendors' router types making backup procedures rather complicated and multi-tiered processes which require the involvement of more experienced GNO team members. When these team members are unavailable or involved with higher priority tasks, the problematic routers are not backed up during the scheduled router backup event. Thus, some vendors' routers may go through several backup events without their configuration data being backed up. Another problem is that some, if not all, GNO teams must utilize several different network management products in order to back up their customers' routers configuration data (or for auditing their GNO IP domains). As briefly discussed above, some products have more automated features than others. Some network management products allow administrators to configure agents that automatically retrieve router configuration data from SNMP compliant routers' MIBs at regular intervals, or cause the router itself to initiate the transfer of the configuration data, while other products merely provide a MIB viewer that allows the administrator to manually download data from routers' MIBs. Here again, the backup process may require the expertise of more experienced GNO team members who are obligated to other GNO service tasks and so routers managed by certain products may miss being backed up. Finally, the structure of the GNO itself lends to some inefficiencies because each GNO team tends to experience identical problems backing up the customers' router configurations.

Additionally, it is difficult to identify trends that may need further investigation by the GNO because each GNO team is largely responsible for its own GNO IP domain(s). Thus, oftentimes a shortcoming linked to a particular vendor router type, customer network, or even network management product goes undetected because the crucial data necessary for identifying the trend is dispersed between several GNO teams. Moreover, with respect to router backup procedures, it becomes increasingly difficult for the GNO to identify weaknesses within a GNO team because the GNO teams are largely autonomous and the team's shortcomings are either unrealized or unreported. Problems associated with router configuration data and/or router backup procedures may become apparent only after a catastrophic event where large amounts of backed-up router configuration data was not unavailable when needed or was stale. Even if a particular problem could be localized at a single GNO team, it is doubtful that the problem could be properly identified because most network management products are not readily adaptable for viewing the accumulated data from the individual device MIBs by different perspectives. Network management databases are frequently difficult or impossible to organize by customer, customer network, vendor router type or GNO team. Thus, while a particular problem may be apparent by carefully scrutinizing the backup event data from the NMA(s), the data itself is generally not configurable using the network management tool itself and must be analyzed using some other mechanism.

In accordance with an exemplary embodiment of the present invention, audit and backup procedures are implemented at the GNO level. By the GNO handling both auditing IP domains and backing up router configuration data, differences between individual vendor products and idiosyncrasies can be managed more effectively, purely due to the scale. First, auditing and backing up customer network data becomes a high priority project at the GNO level because of the scope of the task. Also, it becomes imperative for the GNO to identify or train personnel with the skills needed for each vendor's product, here again because differences in vendor products are no longer trivial due to the increased number of products from each vendor. Furthermore, GNO IP domain bookkeeping is better suited for the GNO level and it is less likely that a GNO IP domain is overlooked.

In further accordance with an exemplary embodiment of the present invention, a new, more adaptable audit and backup process (the B3D) is presented. The B3D development is partially a response to the shortcomings of existing NMAs, but is also necessary because conventional NMAs are scoped for IP domain-level solutions (more analogous to GNO team level) rather than multiple IP domains. In still further accordance with exemplary embodiments of the present invention, audit and backup data acquired by the B3D is viewable from a pertinent GNO perspective, including by GNO IP domain, customer, customer network, network type or configuration, GNO team, node, connected device, device type, device vendor type and even by the type of database from which the data was acquired. In so doing, trends are more likely to be spotted before they result in a critical network event. Customers can be identified that require increased vigilance due to the reliability of their networks or device, or merely because a particular customer tends to reconfigure its network or routers more frequently than the norm. Significantly, the GNO can evaluate its team's performance with respect to each other and with respect to particular customers and vendor router types they service.

In further accordance with still other exemplary embodiments of the present invention, audit and backup processes are both schedulable or event trigged. Audits are automatically initiated after a new GNO IP domain has been defined and all customers, customer networks, nodes and routers attached to the network are identified and the network configuration is saved. Otherwise, audits can be periodically scheduled as a backup. New network configurations are compared to existing configurations and newly-added or deleted network devices are identified. Configuration data for newly-added routers can then be backed up immediately.

With respect to another exemplary embodiment of the present invention, event and warning messages are automatically generated based on the detection of predetermined event occurrences or thresholds. Individual message types can be individually addressed or routed to specific recipients.

The present invention is directed to a system, method and software tool for discovering, scheduling, and performing router configuration backups for GNO customers' routers in accordance with an exemplary embodiment of the present invention. In accordance with another exemplary embodiment of the present invention, the present process may be implemented as a software, hardware or firmware product. In accordance with one embodiment, the present invention is directed to a backup program suite consisting of several different program modules for performing individual domain management functions which may be executed manually or automatically. In accordance with another exemplary embodiment of the present invention, the present process may run in the background with minimal attention from a GNO administrator.

The B3D application is a self-perpetuating process that executes in the background and may be implemented as a software application loaded on the CMDS server, firmware on the CMDS server or some other network device that can see the GNO's IP domains, or alternatively, as a special purpose network device connected to the GNO's IP domains. Turning again to FIG. 1B, server 100 is shown as server within a GNO service system infrastructure for hosting the router configuration backup application of the present invention. The B3D lives on the server 100 server and is dependent upon the existence and proper configuration of IP domain application servers 140, 142, 144, 146, 148, 150 and 152.

Server 100 is a network element in a distributed data processing system or network of computers, referred to herein as a global network. The distributed data processing system contains IP Domain I 102, IP Domain II 104, . . . IP Domain m 114 described above, which is the medium used to provide communications links between various devices and computers connected together within the distributed data processing system. One of ordinary skill in the art would readily appreciate that the global network, or distributed data processing system, may include permanent connections, such as wire or fiber optic cables, or temporary connections made through telephone connections.

In the depicted example, a server 100 is connected to the global network; in addition, clients may also be connected to the network. These clients may be, for example, personal computers, work stations, or network computers which may communicate or otherwise interface with the B3D application on server 100. In the depicted example, server 100 connected to the global network may be implemented as a symmetric multiprocessor (SMP) system including a plurality of processors connected to a system bus. Alternatively, a single processor system may be employed. Server 100 may employ a peripheral component interconnect (PCI) local bus architecture or other bus architectures such as Micro Channel and Industry Standard Architecture (ISA) for connecting the processor(s) and main memory to an integrated memory controller and cache memory for the processor(s). Additional connections to the PCI local bus may be made through direct component interconnection, through add-in boards or via bus adapters to other types of bus systems. A bus adapter (e.g., a Small Computer System Interface (SCSI) host bus adapter) may provide a connection for a hard disk drive, tape drive, DVD-ROM drive, CD-ROM drive and/or other memory devices where the B3D application will reside while not being executed. It is expected during execution that all or part of the B3D application will be loaded into the main memory of server 100. Additionally, an expansion bus interface provides a connection for a keyboard and mouse adapter for interacting with the B3D application and graphics adapter (e.g., provides a connection for a display screen). As is well known in the art, an operating system runs on the processor and is used to coordinate and provide control of various components within server 100. The operating system may be a commercially available operating system such as OS/2, which is available from International Business Machines Corporation. “OS/2” is a trademark of International Business Machines Corporation or Windows which is available from Microsoft Corporation. Instructions for the operating system and applications or programs, including the B3D application, are located on storage devices, such as the aforementioned hard disk drive and may be loaded into the main memory for execution by the processor(s).

It should also be understood that while in the depicted example the B3D application resides on server 100, the B3D application may reside on any one of a plurality of servers and/or network devices, but the IP domain application servers 140, 142, 144, 146, 148, 150 and 152 must be properly configured for the application. Moreover, the application servers should be visible from, and be able to communicate with, the server hosting the B3D application.

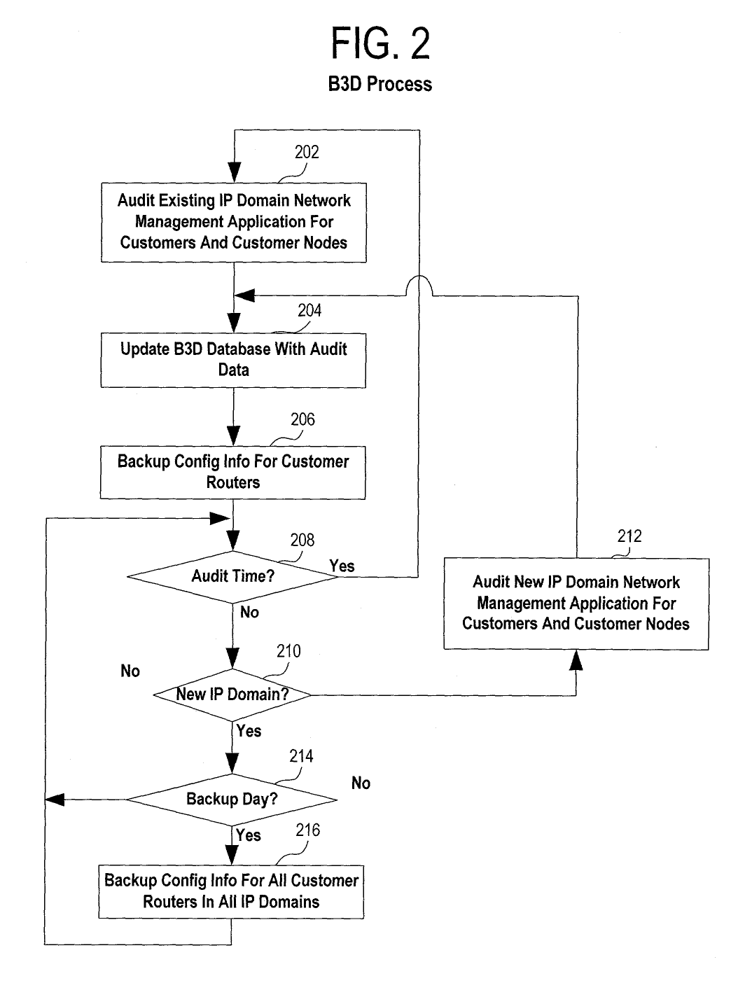

Turning now to FIG. 2, a flowchart depicting a high-level view of the B3D process for automatically auditing IP domains and backing up configuration data for customers' routers attached to networks in the audited domains is presented in accordance with an exemplary embodiment of the present invention. The present flowchart is depicted as a self-perpetuating process that executes in the background and may be implemented as a software application loaded on the CMDS server, firmware on the CMDS server or some other network device that can see the GNO's IP domains, or alternatively, as a special purpose network device connected to the GNO's IP domains. The B3D lives on the CMDS server, for example server 100, and is dependent upon the existence and proper configuration of the IP domain application servers, for example IP domain application servers 140, 142, 144, 146, 148, 150 and 152. The MSD must accept the standard configuration document for the domain application servers. Although the present invention is shown as a self-executing iterative process, the exemplary process could also be implemented as a manual process requiring an administrator to manually instantiate the method.

As briefly discussed above, the depicted process includes auditing the domain and backing up router configuration for routers maintained in the domain. For purposes of describing the present invention, domains have been generally defined in accordance with the Internet protocol specification; however, the present invention will function satisfactorily using any other basis for defining a domain that can be supported by network management products. The depicted process begins on the assumption that a predetermined event has occurred thus triggering an audit; the event is usually a time occurrence. The occurrence of the time event triggers an audit sub-process and the domain network application servers serviced by the GNO are audited (step 202). During the audit, the B3D functionality accesses the NMA databases and identifies customers and customer networks managed by the application. Information regarding network nodes identified by the NMA is also retrieved along with the identity of network devices on the nodes that were discovered by the NMA. The process updates the B3D database with the current audit data (step (204). At the first iteration of the process, the B3D database is empty. Thereafter, the existing B3D database entries are compared to the current audit data for determining any newly-added or deleted routers in the GNO domains. The identity (usually the IP address) of any newly-added routers are included in the B3D database while any routers that are no longer present in the domain have their identities removed from the B3D database. Next, any new routers present in the domain do not have their configuration data backed up in the B3D database; therefore, those routers' configuration data are backed up (step 206).

At this point, the process determines whether or not it is time to audit the GNO domains (step 208). If so, the process returns to step 202 and flows back to the present step. However, as the audit process has just terminated, it is expected that there will be some respite until the next audit. A check is then made to determine whether or not a new domain is being serviced by the GNO (step 210). This step may be alternatively triggered by an administrator defining a new domain in the B3D. The presence of the new domain may be ascertained by comparing existing B3D domain identities with the domains identified in the audit, or may instead be defined in the B3D process by an administrator. If the B3D process detects a new domain since the last audit, that domain must be defined in the B3D. Therefore, the new domain may not have been audited and the B3D database will not contain any information about the domain. Thus, the B3D functionality accesses the NMA databases for the new domain and identifies customers and customer networks managed by the application (step 212). The process updates the B3D database with the audit data associated with the new domain (step (204), including adding any routers to the B3D database that are present in the domain. Next, configuration information for the routers present in the new domain is backed up in the B3D database (step 206).

Returning to step 210, if no new domains are identified, the process determines whether or not it is time to back up configuration data for routers in the GNO domains (step 214). It is expected that most backup events will occur during low traffic times, usually late at night on predetermined backup days. If the process then determines to back up the router configuration data, the B3D process communicates with each router identified in the B3D database and requests its configuration data (step 216). Thus, in accordance with one exemplary embodiment of the present invention, the B3D itself backs up the router configuration data by communicating directly with the customers' router in the GNO domains. Clearly, some, if not all, of the NMA's databases may contain additional copies of the routers' configuration data. Thus, in accordance with another exemplary embodiment of the present invention, the B3D reads router configuration data from the NMA's databases and mirrors that configuration data in its own database. Regardless of how the routers are backed up, once completed, the process recursively loops through step 208 and checks for an audit triggering event, then the presence of new domains (step 210) and finally a backup triggering event (step 214).

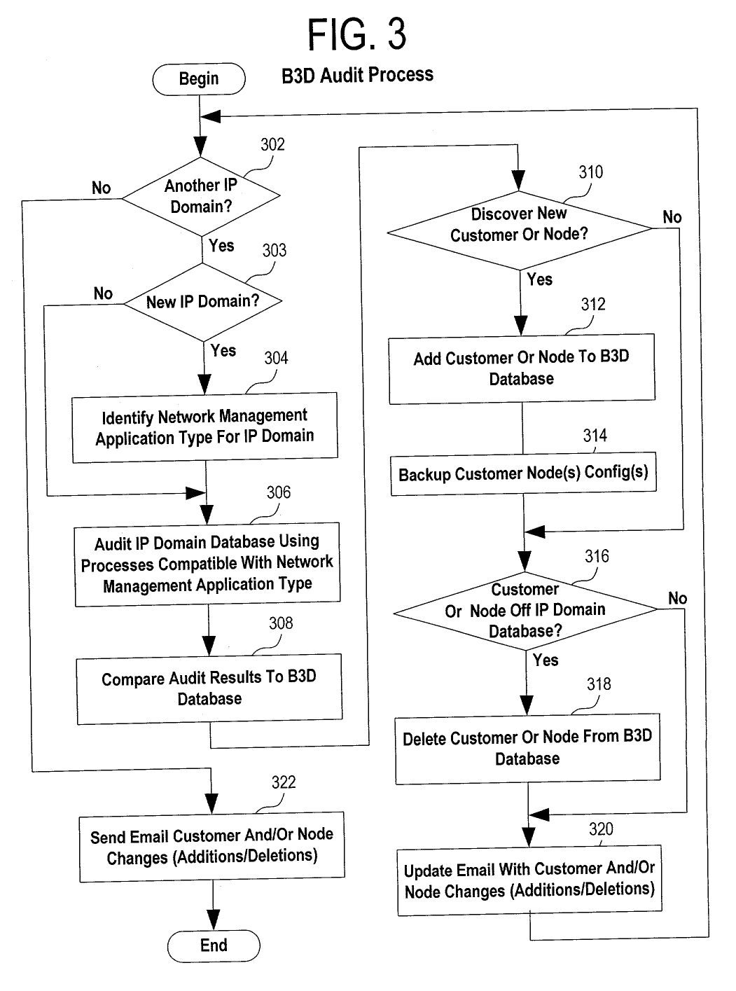

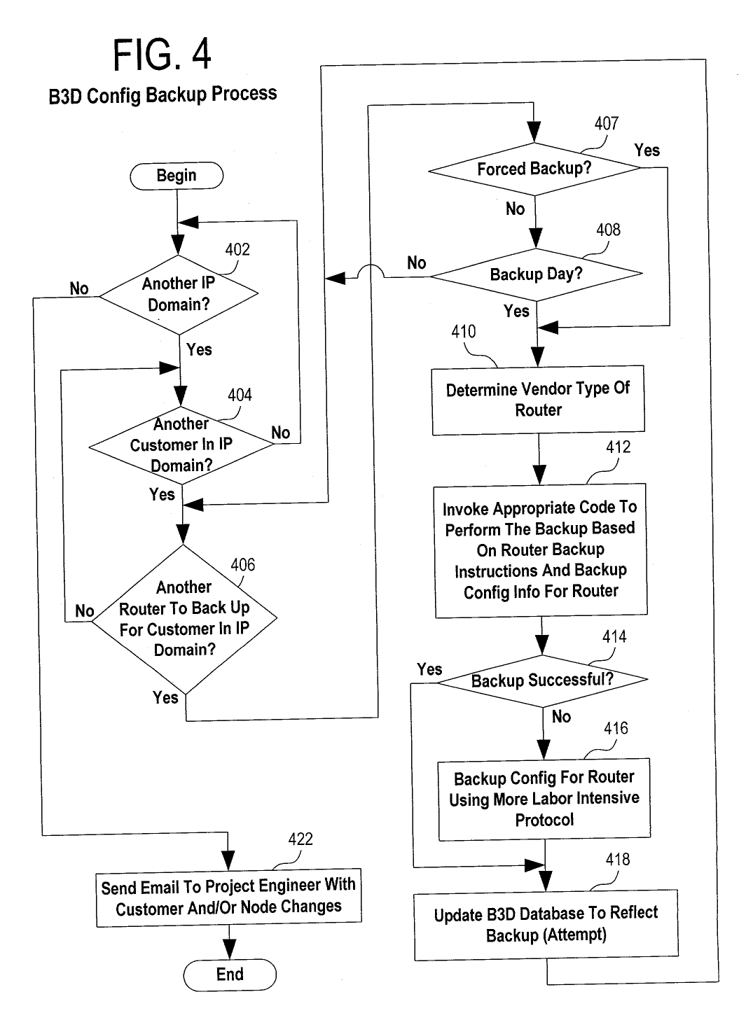

In accordance with exemplary embodiments of the present invention, FIGS. 3 and 4 are flowcharts depicting lower-level views of the B3D sub-processes for auditing and backing up configuration data. Referring now to FIG. 3, a flowchart depicting a low-level view of the B3D audit process for auditing IP domains and backing up configuration data for customers' routers attached to networks in the audited domains is presented in accordance with an exemplary embodiment of the present invention. Each night all Network Management systems are polled and an audit is performed against the B3D database to determine if any new customers have been added to management. If so, then a second discovery is performed for that customer to determine their nodes. These are then added to the B3D database and an e-mail is sent to the technical support mailing list identifying the new customer and directing them to update the customer with the correct password. Once that is complete, then the backups will happen automatically and appear in the common area for quick and easy retrieval when needed.

The present flowchart depicts the audit process as a complete and independent process, but might instead be considered a sub-process to that shown in FIG. 2, triggered by an affirmative response at either step 208 or step 210. The present process begins with a check to determine whether or not another domain is present to be audited (i. e., one that has not been audited in response to the present execution of the process (step 302)). If not, an e-mail is sent to GNO administrators with the identities of customer and/or node changes (i.e., customer and/or node changes in the B3D database from the last execution of the process (step 322)), after which the process ends.

If, on the other hand, all of the GNO-serviced domains have not been audited, the process determines if the next domain to be audited is a new domain that was not present in the B3D database during the previous audit (step 303). If the next domain is a new domain, then the B3D process must locate the domain application server for the domain and then identify the type of NMA running on the server (step 304). As discussed above, presently there are numerous network management products available from various vendors and it cannot be assumed that every vendor's NMA database is similarly structured. Therefore, in accordance with one exemplary embodiment of the present invention, the B3D specification contains an auxiliary specification to handle ambiguities, harmonize definitions and specify options between each vendor type of NMA specification and the B3D specification. The auxiliary specification is used to translate database variables from the vendor's NMA database to the B3D database. This concept is similar to the mechanism used by many interface engines currently available and is well understood by those of ordinary skill in the art. In accordance with an alternative embodiment, the B3D process contains sub-processes for each type of NMA expected to be encountered. These sub-processes are compatible with one or more types of NMAs, thereby allowing the B3D to audit the domain database maintained by those vendor types of NMA(s). However, the vendor type of NMA must be identified before using either the auxiliary specification or the sub-processes. Once the type of NMA is known, the NMA database can be audited using either the B3D auxiliary specification or a compatible sub-process (step 306). Notice here that at step 303, if the domain to be audited is not a new domain, then the B3D process merely circumvents step 304 and audits the NMA database as described directly above.

Next, the current audit results are compared to the B3D database (step 308) and checked to determine if new customers or nodes have been added since the previous audit (step 310). Customers or nodes that appear on the current audit that are not currently in the B3D database indicate that the customers and network devices that have been added to a domain subsequent to the previous audit were not included in the current B3D database. If new customers and/or nodes are discovered, they must be added to the B3D database (step 312) and the configuration data for the newly-added router(s) backed up within the B3D database (step 314). In order to back up the newly-discovered router, the B3D process retrieves information necessary for backing up this particular router. A GNO may support tens of thousands of different customers each having various types of vendor routers configured in myriad network configurations and must be able to retrieve configuration data from each vendor router type. Therefore, the B3D maintains a database of backup requirements for each vendor type router that the process might encounter and retrieves the information based on the type of vendor router. The process invokes the code for the particular vendor type to perform the backup and the router configuration data is backed up (step 412). The B3D process then verifies that the backup attempt was successful (step 414).

Returning to step 310, if it is determined that no new customers or nodes are discovered in the audit, then the B3D database must be checked for customers or nodes that have dropped out of the domain. When customers and/or nodes entries in the B3D database do not correlate to respective customers and/or nodes in the current audit, then those customers and/or network devices have dropped off the domain after the previous audit. Those customers and routers must be deleted from the B3D database (step 318) because the B3D database forms the basis for future router configuration backups. As will be discussed in greater detail below with respect to FIG. 4, if the B3D database contains superfluous router entries, then the B3D backup process will attempt to back up the routers corresponding to the entries regardless of whether or not the routers physically exist. In practice, the B3D will initiate several backup attempts using ever increasing, more intensive backup methods. Thus, the B3D backup process will expend an inordinate amount of time attempting the backup configuration data for routers that are not in the domain. In addition to the wasted backup attempts, the B3D process will automatically alert the GNO team servicing any routers that cannot be backed up. If the GNO team does not verify that the router actually exists in the domain using the NMA, the team may attempt manual backup procedures, etc. on a router not physically in the domain. Additionally, the failed backup attempts logged in the B3D database will skew the results for the cumulative, team and customer router configuration backup summaries.

Finally, once the audit has been completed for the domain, the audit results for the domain for the customer (i. e., additions, deletions, etc.) are updated with the results of the current audit (step 320). From there the process reverts to step 302 where the B3D process checks for another domain. The process continues to recursively iterate through the process steps until the process can find no more domains to audit. At that time, the process transmits the e-mail with the customer audit results to the responsible administrators (step 322 ) and the audit process ends.

Once the B3D process completes the audits of the GNO domains, those results can be used for scheduling router configuration backups. Referring now to FIG. 4, a flowchart depicting a low-level view of the B3D backup process for backing up router configuration data for routers in the GNO IP domains is presented in accordance with an exemplary embodiment of the present invention. It is expected that the B3D backup process will be executed on a daily basis, usually from late at night until the early morning. As described above, efficient router configuration backups depend upon accurate customer and network configuration data being obtained by the B3D auditing process. The backup process is a recursive routine that iteratively processes within router, customer and domain levels. The process begins by attempting to identify a domain with customers that have routers to be backed up (step 402). Once a suitable domain is identified, the process recursively checks for customers in the domain (step 404). Each customer in the domain is then checked for routers to be backed up (step 406). Once a router is identified in the domain for the customer, the B3D determines if a forced backup of the router configuration is necessary regardless of whether or not the backup day has occurred for the customer's router (step 407). Reasons for a forced backup include not having any backup configuration information for the router in the B3D database, stale backup configuration on file with the B3D database, such as might result from an unsuccessful backup attempt on a previous backup day or manual intervention by an administrator by setting a flag to override the backup day for an immediate forced backup of the router configuration. If a forced backup is necessary, the process circumvents the check for the occurrence of a backup day for the router and proceeds to step 410 and initiates the backup subroutine.

If, one the other hand, a forced backup is not necessary, then the B3D process determines if the backup day has occurred for current router for the customer in the domain being processed (step 408). If not, the process reverts to step 406 where the domain is again checked for another router for the customer. If, at step 408, the B3D process establishes that the backup day has occurred for this particular customer's router in the domain, the B3D process retrieves information necessary for backing up this particular router.

Once the B3D process identifies a router to be backed up, the B3D process determines the vendor router type for the router identified in step 406 (step 410). As described in detail above, several different types of routers supplied by various router vendors may be present within each separate domain. A GNO may support tens of thousands of different customers each having various types of vendor routers configured in myriad network configurations and it must be able to retrieve configuration data from each vendor router type. The B3D maintains a database of backup requirements for each vendor type router that the process might encounter and retrieves the information based on the type of vendor router. The process retrieves the appropriate code for the particular vendor type of router for backing up that router.

The process invokes the code for the particular vendor type to perform the backup and the router configuration data is backed up (step 412). The B3D process then verifies that the backup attempt was successful (step 414). This check might be an acknowledgement for the router itself or the B3D might check the data in the B3D database for new router configuration data. If the backup attempt was successful, the B3D process flows to step 418 where the B3D database is updated to reflect the successful backup and the process reverts to step 406 to check the domain for another router for the customer. If, on the other hand, the B3D cannot confirm that the router configuration data was backed up at step 414, then the process uses a more brute force method for backing up the router's configuration data (step 416). At this point, an e-mail might also be updated with the identities of customers and/or routers that could not be backed up using the code from the backup requirements listed in the B3D database.

In any case, it is expected that two backup attempts will be undertaken before the B3D process gives up and moves on to another router in which case the B3D process flows to step 418 and updates the B3D database to reflect the unsuccessful backup attempt. However, the B3D process of the present invention is extremely flexible, thereby allowing for more or less backup attempts than the two attempts described above. Once the second attempt has concluded, the results of that attempt are updated in B3D database as described above (step 418), and the process reverts to step 406 to check for another router until no more routers are found for any customer in any domain. At that point, the B3D process transmits the e-mail with the backup information to GNO administrators and the process ends.

In addition to sending e-mails with backup information, the B3D may be configured to be disseminated into daily, weekly or monthly status reports to GNO managers via e-mail, in addition to those status reports resulting from backup events.

As described above, the B3D maintains a separate database that auto-discovers new customers and nodes nightly from the various network management systems regardless of the IP domain from which they are being managed. It will then discover the vendor of the router and perform a configuration loop of that node on a weekly basis. These backups are stored in a common location for GNO and other technical support personnel to review the configuration data. The database may also be used to generate a team, customer or GNO report for real-time viewing via a web browser or as a command line summary on an administrator's control panel. In addition, e-mails are sent out weekly to the GNO, technical support engineers and managers regarding the status of all GNO router backups. In the event of an outage, this is a significant time saver.

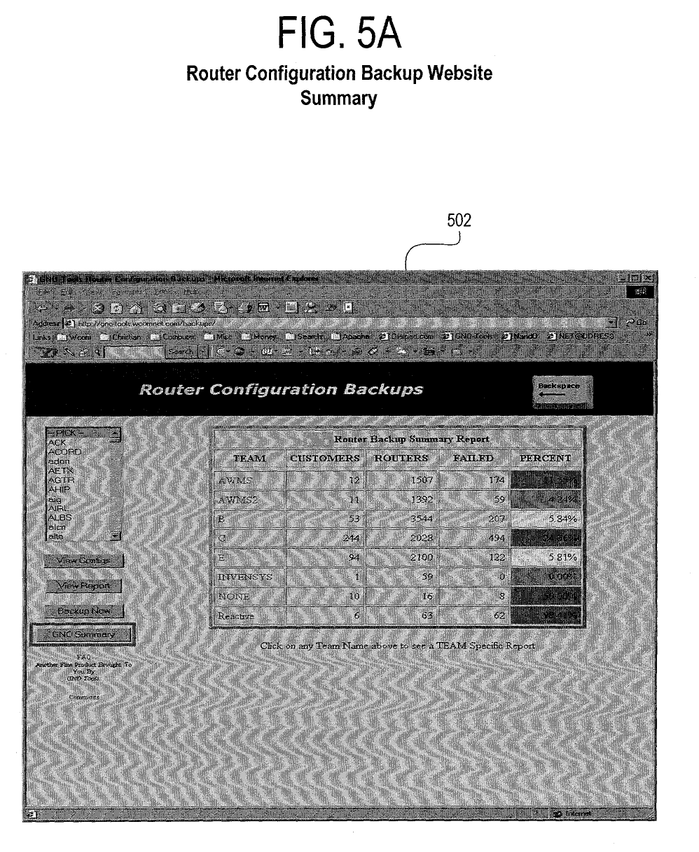

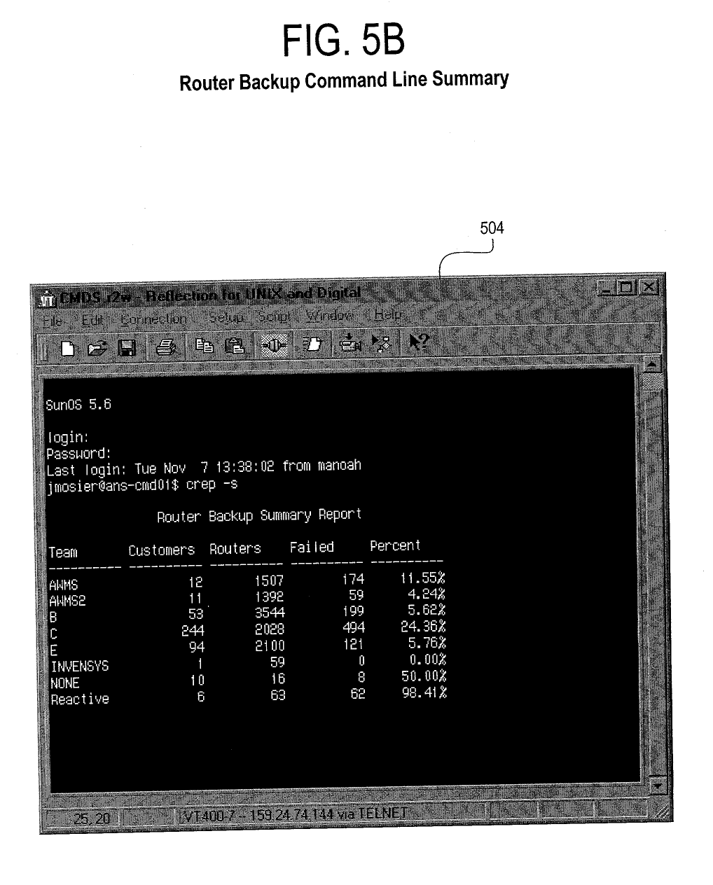

Turning now to FIGS. 5A and 5B, screen shots are depicted of a router configuration backup summary in accordance with an exemplary embodiment of the present invention. As discussed elsewhere above, the present invention allows for real-time GNO reports to be generated for router configuration data. These reports may be viewed as an http page via a web browser or, alternatively as a command line summary on an administrator's console. FIGS. 5A and 5B depict a cumulative summary of all routers' services by the GNO. Screen shot 502 on FIG. 5A depicts the http page as viewed on a web browser for any authorized network device capable of communicated and interacting with the CMDS server, or any other server, in which the B3D resides. Screen shot 504 on FIG. 5B depicts the command line summary as seen on an administrator's console, such as might be seen on the console associated with the CMDS server, or any other server, in which the B3D resides.

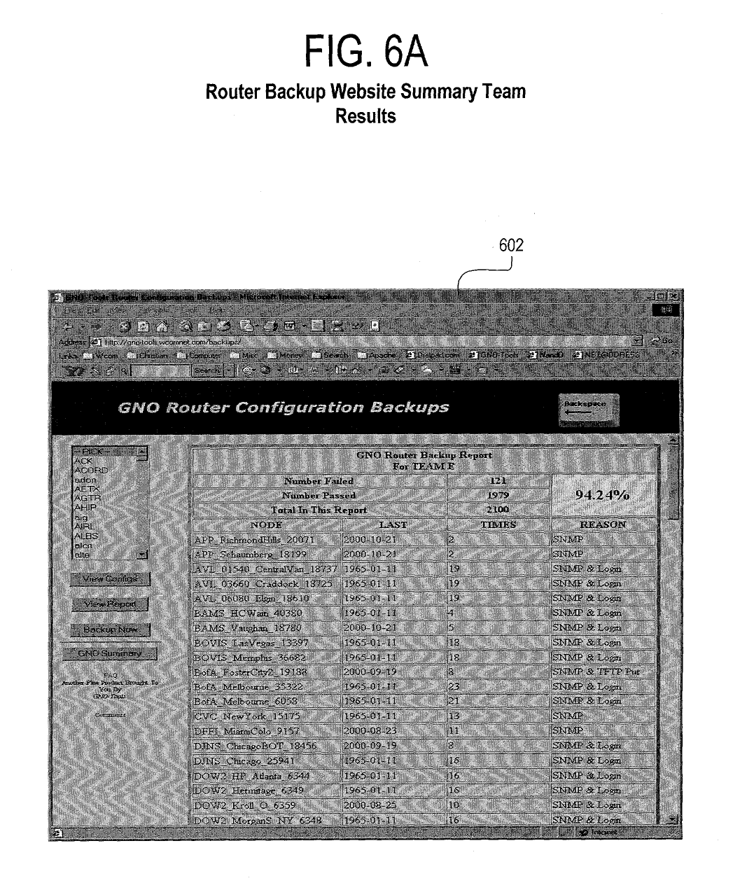

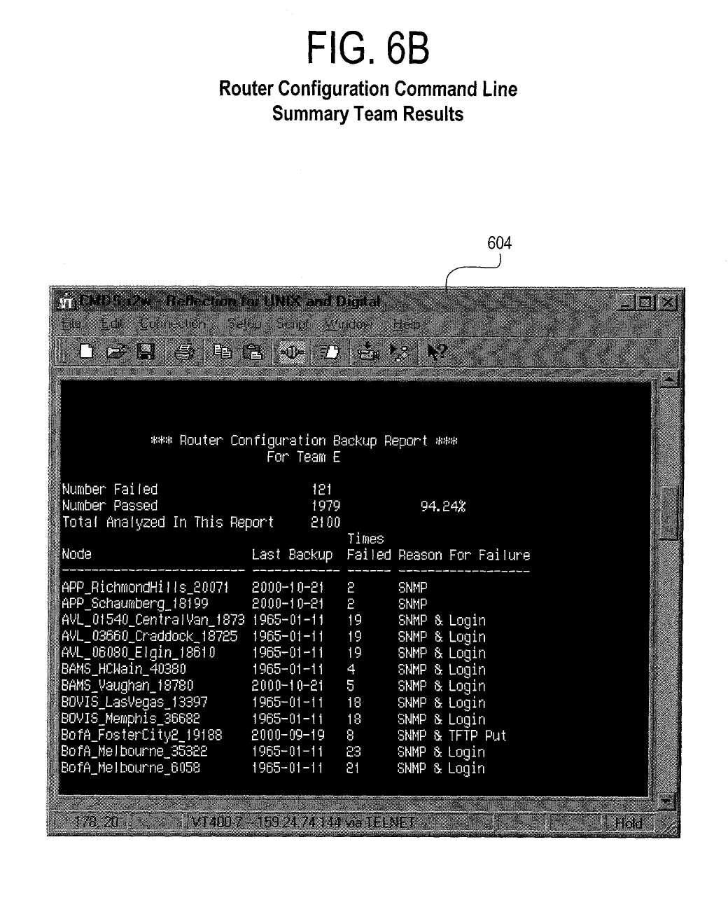

However, as was mentioned above, the B3D database is extremely flexible, allowing GNO personnel to view router configuration data from a variety of pertinent perspectives. Referring now to FIGS. 6A and 6B, screen shots are depicted of a router configuration backup GNO team summary in accordance with an exemplary embodiment of the present invention. FIGS. 6A and 6B depict a summary of all routers serviced by the GNO viewed from a GNO team perspective. Screen shot 602 on FIG. 6A depicts the http page as it might be viewed on a web browser from a remote device, while screen shot 604 on FIG. 6B depicts the command line summary as seen on an administrator's console, normally local to the server hosting the B3D application.

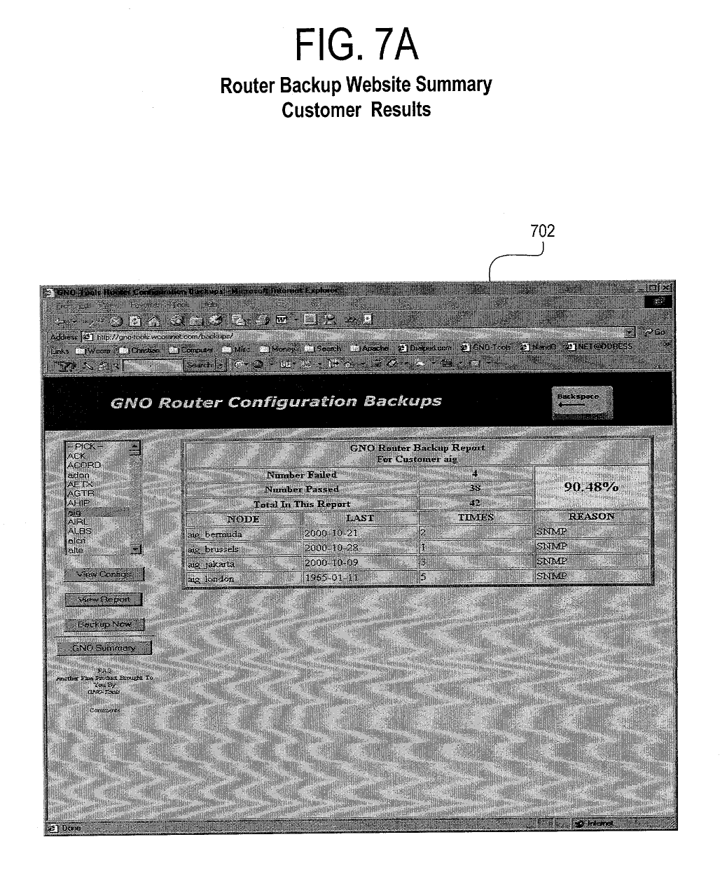

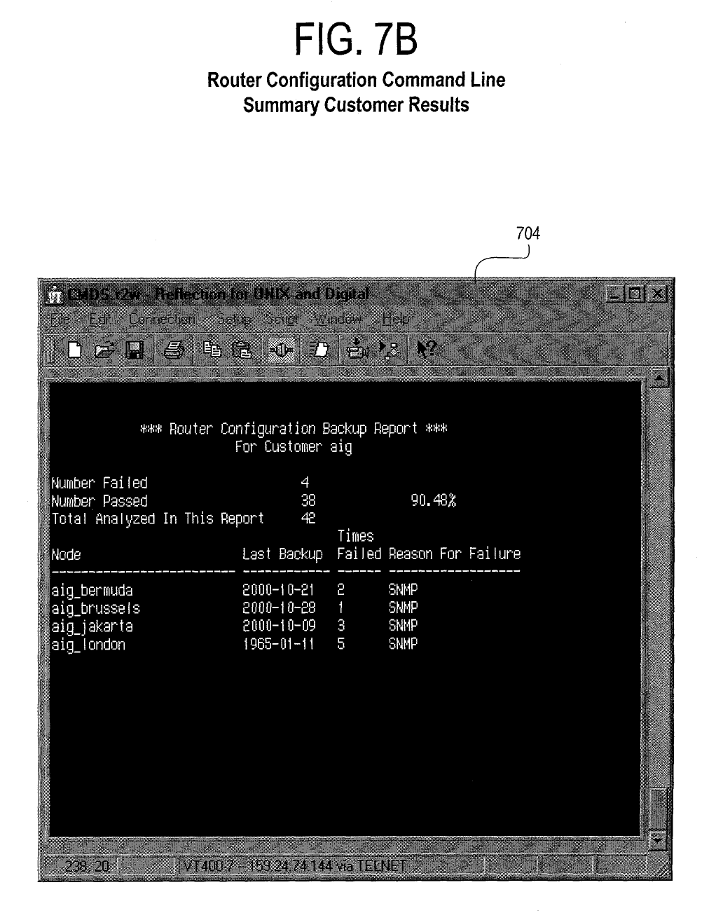

Finally, FIGS. 7A and 7B are screen shots depicting a router configuration backup GNO customer summary in accordance with an exemplary embodiment of the present invention. FIGS. 7A and 7B depict a summary of all routers serviced by the GNO, viewed from a GNO customer perspective. Screen shot 702 on FIG. 7A depicts the http page as viewed on a web browser, and screen shot 702 on FIG. 7B depicts the command line summary as seen on an administrator's console.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for backing up router configuration information for routers physically configured across a plurality of network domains comprising:
providing a network domain router database, wherein said network domain router database comprises router information for a plurality of routers physically configured in at least some of the plurality of network domains;
auditing each of the plurality of network domains for router information;
updating the domain router database with router information obtained by auditing each of the plurality of network domains; and
backing up configuration information for at least one router based on router information in the network domain router database.

2. The method recited in claim 1 wherein auditing each of the plurality of network domains for router information further comprises:
identifying a network management application type for one of the plurality of network domains;
identifying a compatible audit process for the network management application type;
auditing a network domain database associated with the one of the plurality of network domains using the compatible audit process for the network management application type of said one of the plurality of network domains, wherein auditing includes discovering at least one node in the network domain database; and
identifying at least one router associated with said at least one node.

3. The method recited in claim 2 wherein auditing each of the plurality of network domains for router information is performed recursively for each of the plurality of network domains.

4. The method recited in claim 2 wherein updating the domain router database with router information obtained by auditing each of the plurality of network domains further comprises:
checking said network domain router database for router information for the at least one router associated with said at least one node; and
entering router information for the at least one router in said network domain router database based on the outcome of checking said network domain router database for router information for the at least one router.

5. The method recited in claim 2 wherein auditing each of the plurality of network domains for router information and updating the domain router database with router information are each performed recursively for each of the plurality of network domains.

6. The method recited in claim 4 wherein backing up configuration information for at least one router based on router information in the network domain router database further comprises:
backing up configuration information for the at least one router associated with said at least one node based outcome of checking said network domain router database for router information for the at least one router.

7. The method recited in claim 2 wherein backing up configuration information for at least one router based on router information in the network domain router database further comprises:
providing a time period for backing up router configuration information for routers physically configured in said plurality of network domains;
accessing said network domain router database for router information for a plurality of routers physically configured in one of the plurality of network domains;
determining whether a time period for backing up router configuration information of one of the plurality of routers physically configured in one of the plurality of network domains;
identifying a vendor type router for said one of the plurality of routers;
retrieving appropriate instructions for backing up vendor type router; and
backing up configuration information for said one of the plurality of routers using said appropriate instructions for backing up vendor type router.

8. The method recited in claim 7 wherein backing up configuration information for at least one router based on router information in the network domain router database is performed recursively for each of the plurality of network domains.

9. The method recited in claim 8 further comprises:
ascertaining whether backing up configuration information for said one of the plurality of routers was completed successfully.

10. The method recited in claim 9 further comprises:
implementing alternative backup procedures for backing up configuration information for said one of the plurality of routers based on the backing up configuration information for said one of the plurality of routers not being completed successfully.

11. The method recited in claim 10 wherein backing up configuration information for at least one router based on router information in the network domain router database and implementing alternative backup procedures for backing up configuration information for said one of the plurality of routers are performed recursively for each of the plurality of network domains.

12. The method recited in claim 6 wherein backing up configuration information for at least one router based on router information in the network domain router database further comprises:
providing a time period for backing up router configuration information for routers physically configured in said plurality of network domains;
accessing said network domain router database for router information for a plurality of routers physically configured in one of the plurality of network domains;
determining whether a time period for backing up router configuration information of one of the plurality of routers physically configured in one of the plurality of network domains;
identifying a vendor type router for said one of the plurality of routers;
retrieving appropriate instructions for backing up vendor type router; and
backing up configuration information for said one of the plurality of routers using said appropriate instructions for backing up vendor type router.

13. The method recited in claim 12 wherein backing up configuration information for at least one router based on router information in the network domain router database is performed recursively for each of the plurality of network domains.

14. The method recited in claim 13 further comprises:
ascertaining whether backing up configuration information for said one of the plurality of routers was completed successfully.

15. The method recited in claim 14 further comprises:
implementing alternative backup procedures for backing up configuration information for said one of the plurality of routers based on the backing up configuration information for said one of the plurality of routers not being completed successfully.

16. The method recited in claim 15 wherein backing up configuration information for at least one router based on router information in the network domain router database and implementing alternative backup procedures for backing up configuration information for said one of the plurality of routers are performed recursively for each of the plurality of network domains.

17. The method recited in claim 3 wherein said router information for a plurality of routers in said network domain router database comprises a plurality of customers identities associated with the respective plurality of routers, auditing a network domain database associated with the one of the plurality of network domains, the method further comprises:
recursively selecting each of the plurality of customers' identities, auditing said network domain database associated with the one of the plurality of network domains on the basis of said recursively selected customers identity.

18. The method recited in claim 7 wherein said router information for a plurality of routers in said network domain router database comprises a plurality of customers' identities associated with the respective plurality of routers, backing up configuration information for at least one router based on router information in the network domain router database, the method further comprises:
recursively selecting each of the plurality of customers' identities, backing up said configuration information for at least one router associated with the one of the plurality of network domains on the basis of said recursively selected customer identity.

19. The method recited in claim 12 wherein said router information for a plurality of routers in said network domain router database comprises a plurality of customers' identities associated with the respective plurality of routers, backing up configuration information for at least one router based on router information in the network domain router database, the method further comprises:
recursively selecting each of the plurality of customers identities, backing up said configuration information for at least one router associated with the one of the plurality of network domains on the basis of said recursively selected customers identity.

20. The method recited in claim 1, wherein said network domains are Internet protocol network domains.

21. A computer program product implemented on a computer readable medium for implementing a method for backing up router configuration information for routers physically configured across a plurality of network domains comprising:
instruction for providing a network domain router database, wherein said network domain router database comprises router information for a plurality of routers physically configured in at least some of the plurality of network domains;
instruction for auditing each of the plurality of network domains for router information;
instruction for updating the domain router database with router information obtained by auditing each of the plurality of network domains; and
instruction for backing up configuration information for at least one router based on router information in the network domain router database.

22. The computer program product recited in claim 21 wherein the instruction for auditing each of the plurality of network domains for router information further comprises:
instruction for identifying a network management application type for one of the plurality of network domains;
instruction for identifying a compatible audit process for the network management application type;
instruction for auditing a network domain database associated with the one of the plurality of network domains using the compatible audit process for the network management application type of said one of the plurality of network domains, wherein auditing includes discovering at least one node in the network domain database; and
instruction for identifying at least one router associated with said at least one node.

23. The computer program product recited in claim 22 wherein the instruction for auditing each of the plurality of network domains for router information is performed recursively for each of the plurality of network domains.

24. The computer program product recited in claim 22 wherein the instruction for updating the domain router database with router information obtained by auditing each of the plurality of network domains further comprises:
instruction for checking said network domain router database for router information for the at least one router associated with said at least one node; and
instruction for entering router information for the at least one router in said network domain router database based on the outcome of checking said network domain router database for router information for the at least one router.

25. The computer program product recited in claim 22 wherein the instruction for auditing each of the plurality of network domains for router information and the updating the domain router database with router information are each performed recursively for each of the plurality of network domains.

26. The computer program product recited in claim 24 wherein the instruction for backing up configuration information for at least one router based on router information in the network domain router database further comprises:
instruction for backing up configuration information for the at least one router associated with said at least one node based outcome of checking said network domain router database for router information for the at least one router.

27. The computer program product recited in claim 22 wherein the instruction for backing up configuration information for at least one router based on router information in the network domain router database further comprises:
instruction for providing a time period for backing up router configuration information for routers physically configured in said plurality of network domains;
instruction for accessing said network domain router database for router information for a plurality of routers physically configured in one of the plurality of network domains;
instruction for determining whether a time period for backing up router configuration information of one of the plurality of routers physically configured in one of the plurality of network domains;
instruction for identifying a vendor type router for said one of the plurality of routers;
instruction for retrieving appropriate instructions for backing up vendor type router; and
instruction for backing up configuration information for said one of the plurality of routers using said appropriate instructions for backing up vendor type router.

28. The computer program product recited in claim 27 wherein the instruction for backing up configuration information for at least one router based on router information in the network domain router database is performed recursively for each of the plurality of network domains.

29. The computer program product recited in claim 28 further comprises:
instruction for ascertaining whether backing up configuration information for said one of the plurality of routers was completed successfully.

30. The computer program product recited in claim 29 further comprises:
instruction for implementing alternative backup procedures for backing up configuration information for said one of the plurality of routers based on the backing up configuration information for said one of the plurality of routers not being completed successfully.

31. The computer program product recited in claim 30 wherein the instruction for backing up configuration information for at least one router based on router information in the network domain router database and implementing alternative backup procedures for backing up configuration information for said one of the plurality of routers are performed recursively for each of the plurality of network domains.

32. The computer program product recited in claim 26 wherein the instruction for backing up configuration information for at least one router based on router information in the network domain router database further comprises:
instruction for providing a time period for backing up router configuration information for routers physically configured in said plurality of network domains;
instruction for accessing said network domain router database for router information for a plurality of routers physically configured in one of the plurality of network domains;
instruction for determining whether a time period for backing up router configuration information of one of the plurality of routers physically configured in one of the plurality of network domains;
instruction for identifying a vendor type router for said one of the plurality of routers;
instruction for retrieving appropriate instructions for backing up vendor type router; and
instruction for backing up configuration information for said one of the plurality of routers using said appropriate instructions for backing up vendor type router.

33. The computer program product recited in claim 32 wherein the instruction for backing up configuration information for at least one router based on router information in the network domain router database is performed recursively for each of the plurality of network domains.

34. The computer program product recited in claim 33 further comprises:
instruction for ascertaining whether backing up configuration information for said one of the plurality of routers was completed successfully.

35. The computer program product recited in claim 34 further comprises:
instruction for implementing alternative backup procedures for backing up configuration information for said one of the plurality of routers based on the backing up configuration information for said one of the plurality of routers not being completed successfully.

36. The computer program product recited in claim 35 wherein the instruction for backing up configuration information for at least one router based on router information in the network domain router database and implementing alternative backup procedures for backing up configuration information for said one of the plurality of routers are performed recursively for each of the plurality of network domains.

37. The computer program product recited in claim 23, wherein said router information for a plurality of routers in said network domain router database comprises a plurality of customers' identities associated with the respective plurality of routers, auditing a network domain database associated with the one of the plurality of network domains, the computer program product further comprises:
instruction for recursively selecting each of the plurality of customers' identities, auditing said network domain database associated with the one of the plurality of network domains on the basis of said recursively selected customers identity.

38. The computer program product recited in claim 27 wherein said router information for a plurality of routers in said network domain router database comprises a plurality of customers identities associated with the respective plurality of routers, backing up configuration information for at least one router based on router information in the network domain router database, the computer program product further comprises:
instruction for recursively selecting each of the plurality of customers identities, backing up said configuration information for at least one router associated with the one of the plurality of network domains on the basis of said recursively selected customers identity.

39. The computer program product recited in claim 32 wherein said router information for a plurality of routers in said network domain router database comprises a plurality of customers' identities associated with the respective plurality of routers, backing up configuration information for at least one router based on router information in the network domain router database the computer program product further comprises:
instruction for recursively selecting each of the plurality of customers' identities, backing up said configuration information for at least one router associated with the one of the plurality of network domains on the basis of said recursively selected customers identity.

40. The computer program product recited in claim 1, wherein said network domains are Internet protocol network domains.

41. A system for backing up router configuration information for routers physically configured across a plurality of network domains comprising:
a plurality of network domains, each of said network domains comprising:
a plurality of nodes;
a plurality of routers physically configured in the plurality of network domains, said plurality of routers comprising:
at least one router of a first vendor type; and
at least one router of a second vendor type; and
at least one domain application server, said one domain application server having a network management application and said network management application being a particular type of network management application; and
a global networks operations (GNO) server, said GNO server having a network domain router database comprising router information for the plurality of routers;
means for auditing each of the plurality of network domains for router information;
means for updating the domain router database in the GNO server with router information obtained by auditing each of the plurality of network domains; and
means for backing up configuration information for at least one router based on router information in the network domain router database.

42. The system recited in claim 41 wherein said means for auditing each of the plurality of network domains for router information further comprises:
means for identifying a network management application type for one of the plurality of network domains;
means for identifying a compatible audit process for the network management application type;
means for auditing a network domain database associated with the one of the plurality of network domains using the compatible audit process for the network management application type of said one of the plurality of network domains, wherein auditing includes discovering at least one node in the network domain database; and
means for identifying at least one router associated with said at least one node.

43. The system recited in claim 42 wherein the means for auditing each of the plurality of network domains for router information performs a recursive process for auditing each of the plurality of network domains.

44. The system recited in claim 42 wherein said means for updating the domain router database in said GNO server with router information obtained by auditing each of the plurality of network domains further comprises:
means for checking said network domain router database in said GNO server for router information for the at least one router associated with said at least one node; and
means for entering router information for the at least one router in said network domain router database in said GNO server based on an output of said means for checking said network domain router database.

45. The system recited in claim 42 wherein means for auditing each of the plurality of network domains for router information and means for updating the domain router database with router information each of which performs recursive process over the plurality of network domains.

46. The system recited in claim 44 wherein the means for backing up configuration information further comprises:
means for backing up configuration information for the at least one router associated with said at least one node based on an output of said means for checking said network domain router database for router information for the at least one router.

47. The system recited in claim 42 wherein said means for backing up configuration information for at least one router based on router information in the network domain router database in said GNO server further comprises:
means for providing a time period for backing up router configuration information for routers physically configured in said plurality of network domains;
means for accessing said network domain router database for router information for a plurality of routers physically configured in one of the plurality of network domains;
means for determining whether a time period for backing up router configuration information of one of the plurality of routers physically configured in one of the plurality of network domains;
means for identifying a vendor type router for said one of the plurality of routers;
means for retrieving appropriate instructions for backing up vendor type router; and
means for backing up configuration information for said one of the plurality of routers using said appropriate instructions for backing up vendor type router.

48. The system recited in claim 47 wherein said means for backing up configuration information for at least one router based on router information in the network domain router database performs a recursive for backing up configuration information across each of the plurality of network domains.

49. The system recited in claim 48 further comprises:
means for ascertaining whether backing up configuration information for said one of the plurality of routers was completed successfully.

50. The method recited in claim 46 wherein the means for backing up configuration information for at least one router based on router information in the network domain router database further comprises:
means for providing a time period for backing up router configuration information for routers physically configured in said plurality of network domains;
means for accessing said network domain router database for router information for a plurality of routers physically configured in one of the plurality of network domains;
means for determining whether a time period for backing up router configuration information of one of the plurality of routers physically configured in one of the plurality of network domains;
means for identifying a vendor type router for said one of the plurality of routers;
means for retrieving appropriate instructions for backing up vendor type router; and
means for backing up configuration information for said one of the plurality of routers using said appropriate instructions for backing up vendor type router.

51. The method recited in claim 50 wherein said means for backing up configuration information for at least one router based on router information in the network domain router database performs a recursive process for backing up configuration information across the plurality of network domains.

52. The method recited in claim 51 further comprises:
means for ascertaining whether backing up configuration information for said one of the plurality of routers was completed successfully.

53. The method recited in claim 52 further comprises:
means for implementing alternative backup procedures for backing up configuration information for said one of the plurality of routers based on the backing up configuration information for said one of the plurality of routers not being completed
